(19) United States
(12) Patent Application Publication
(10) Pub. No.: US 2011/0255272 A1
(43) Pub. Date: Oct. 20, 2011

(54) Simulated candle apparatus

(76) Inventor: Yves Privas, Pompano Beach, FL (US)

(21) Appl. No.: 12/932,907

(22) Filed: Mar. 9, 2011

Related U.S. Application Data
(60) Provisional application No. 61/339,872, filed on Mar. 10, 2010.

(51) Int. Cl. F21L 4/00

(52) U.S. Cl. 362/157

(57) ABSTRACT

A simulated candle apparatus includes an upright cylindrical housing having a detachable housing top wall with a lighting circuit affixed to the housing top wall lower surface and an LED light source connected to the lighting circuit and extending above the housing top wall to resemble a candle flame, the housing containing a battery compartment and a power circuit including battery terminals extending into the battery compartment, the power circuit extending to and being in electrical communication with the lighting circuit, and one of the lighting circuit and the power circuit including a magnetic field activated light actuation switch in the form of a magnetically sensitive relay switch. The apparatus preferably includes a wand having a magnetic tip for placement near the light actuation switch to activate and deactivate the light source while resembling a match.

### FILING HISTORY

This application continues from provisional patent application Ser. No. 61/339,872, filed on Mar. 10, 2010.

### BACKGROUND OF THE INVENTION

1. Field of the Invention

The present invention relates generally to the field of lighting devices. More specifically the present invention relates to a simulated candle apparatus including an upright cylindrical housing having a detachable housing top wall with a lighting circuit affixed to the housing top wall lower surface and a light source connected to the lighting circuit and extending above the housing top wall to resemble a candle flame, the housing containing a battery compartment and a power circuit including battery terminals extending into the battery compartment, the power circuit extending to and being in electrical communication with the lighting circuit, and one of the lighting circuit and the power circuit including a magnetic field activated light actuation switch in the form of a magnetically sensitive relay switch. The light source preferably is a light emitting diode (LED). The power circuit can include plug prong terminals extending from the lighting circuit and downwardly from the housing top wall and a plug receptacle having lead wires extending to terminals in the battery compartment. It is specifically preferred that the power circuit include a battery holder soldered onto the PC board lighting circuit, rather than wires extending from the PC board. The apparatus preferably includes a wand having a magnetic tip for placement in activating proximity to the light actuation switch to either activate or deactivate the light source while resembling a candle lighting match.

The apparatus optionally takes the form of a tea light when combined with a fragrance producing gel within a solid annular gel pack cover having a height substantially matching the height of the housing and having an inner diameter sized to receive and closely fit the housing so that the housing and pack appear in combination to be a candle, with the light source protruding above housing and gel pack. The container lid preferably has a magnetic rod connected to and protruding downwardly from the lid lower surface a sufficient distance to be proximal to and operate the magnetically sensitive relay switch, so that placing the lid on the candle cup operates the relay switch to deactivate the light source, just as the flame of a candle would be extinguished by placing a lid on a candle cup and removing the lid from the candle cup operates the relay switch to activate the light source. A remote control preferably is also provided for activating and deactivating the light source. The remote control is particularly useful in restaurant settings, where one of the present apparatus is placed on each of numerous tables, so that they can be turned on or off in unison with a single action of the remote control. The lighting circuit and its functions are described below in the Detail Description.

2. Description of the Prior Art

There have long been candles and candle, alcohol and oil lamps for use on restaurant tables to provide low intensity light to patrons and to lend a romantic atmosphere to the restaurant. A problem with these traditional flame lights is that they have proven time and again to be fire hazards, and can start a rapidly spreading fire by igniting an inflammable table cloth. This is particular true in the case of alcohol and oil lamps where the fuel spills and acts as a fire accelerant. Another problem has been purely economic, in that continual burning of a flame on each table, whether powered by candle wax or a liquid fuel throughout restaurant business hours is very expensive.

Electric simulated candles with LED lights have been provided as an alternative to actual wax candles, while they lose the illusion of being candles when turned off and on with a manually operated switch, while still presenting the inconvenience of lighting them one by one. These simulated candles also lack the fragrance produced by actual candles, and thus seem further artificial. The electronically produced flickering generally does not appear real because they can be obviously non-random.

It is thus an object of the present invention to provide a simulated candle lamp apparatus for placement on restaurant and bar tables and home dining tables which appears to have a flickering candle but in fact has no flame and presents a negligible or absolutely no fire hazard, and in which the flickering can be replaced with a steady light with the operation of a switch.

It is another object of the present invention to provide such a simulated candle lamp apparatus which can be lighted with a wand resembling a long match, the wand having a magnetic tip which activates and deactivates the simulated candle when placed close to the simulated flame produced by an LED, but optionally can be alternatively lighted in unison with several other simulated candles such as in a restaurant using a remote control.

It is still another object of the present invention to provide such a simulated candle lamp apparatus which produces light of a constant brightness as the battery charge diminishes and also saves electricity.

It is yet another object of the present invention to provide such a simulated candle lamp apparatus which produces safe, realistic, simulated ambiance, each unit providing up to 850 hours of flickering illumination which is virtually indistinguishable from an actual candle when housed in a votive holder, table-top lamp fixture, on a tough to reach shelf or a wall sconce, and which can be provided in a water-proof plastic housing suitable for outdoor use.

It is a yet further object of the present invention to provide such a simulated candle lamp apparatus which is realistic, remote controlled, fits most lamps, entirely safe, automatically shuts off after a pre-set length of time, is economical to operate, can be disposable and recyclable, is waterproof, operates reliably in windy outdoor conditions, can be placed where needed and forgotten, remaining at a desired location for its entire lifespan of perhaps six months or more, and which includes elements to create a sleeping mode to deactivate the light source for an extended time, perhaps six months or more, while not in use, such as when stored on a shelf.

It is finally an object of the present invention to provide such a simulated candle lamp apparatus which can take the form of a votive and with a replaceable annular gel pack around the simulated candle assembly which can produce fragrance to simulate a scented candle.

### SUMMARY OF THE INVENTION

The present invention accomplishes the above-stated objectives, as well as others, as may be determined by a fair reading and interpretation of the entire specification.

A simulated candle apparatus is provided including an upright cylindrical housing having a detachable housing top wall with a lighting circuit affixed to the housing top wall lower surface and a light source connected to the lighting circuit and extending above the housing top wall to resemble a candle flame, the housing containing a battery compartment and a power circuit including battery terminals extending into the battery compartment, the power circuit extending to and being in electrical communication with the lighting circuit, and one of the lighting circuit and the power circuit including a magnetic field activated light actuation switch in the form of a magnetically sensitive relay switch. The light source preferably is a light emitting diode (LED). A battery holder such as a pair of contact arms can be soldered onto the PC board directly, so that no wires are needed for the power circuit. The power circuit can include plug prong terminals on extending from the lighting circuit and downwardly from the housing top wall and a plug receptacle having lead wires extending to terminals in the battery compartment. The apparatus preferably includes a wand having a magnetic tip for placement in activating proximity to the light actuation switch to either activate or deactivate the light source while resembling a candle lighting match.

### BRIEF DESCRIPTION OF THE DRAWINGS

Various other objects, advantages; and features of the invention will become apparent to those skilled in the art from the following discussion taken in conjunction with the following drawings, in which:

FIGS. 1-23 illustrate several embodiments of the invention, and its elements.

An appendix of additional descriptive pages are also attached.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

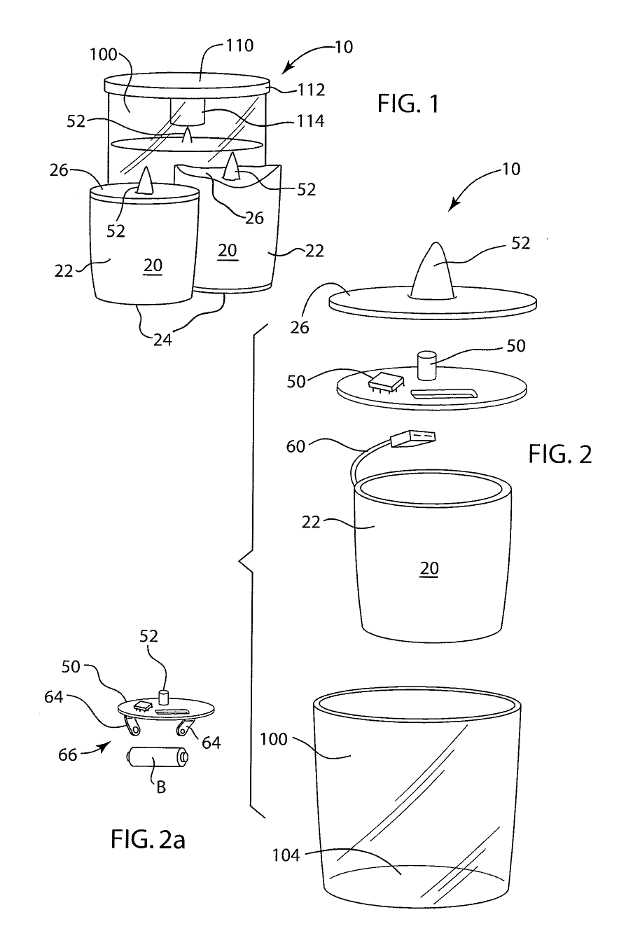

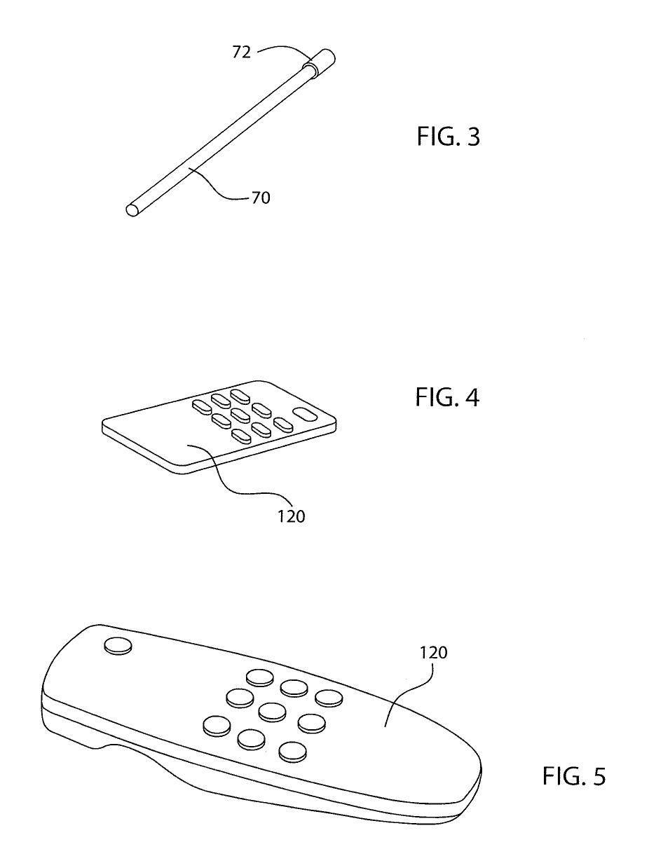

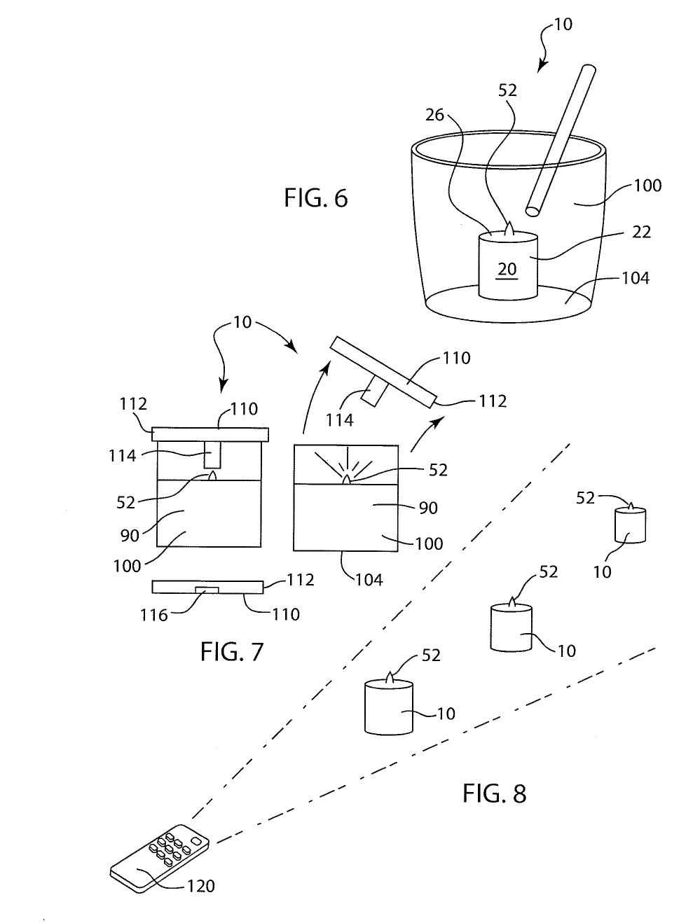

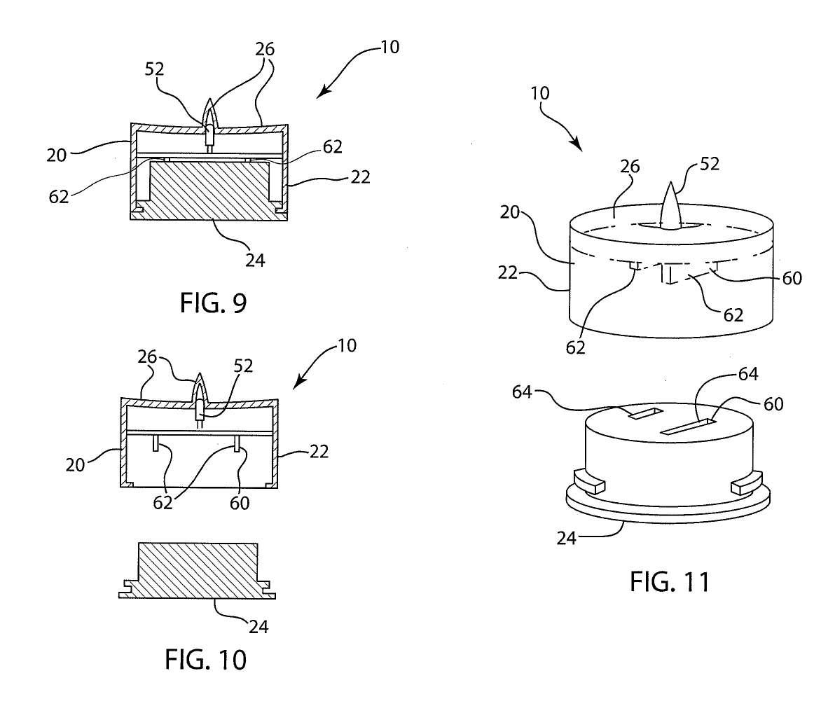

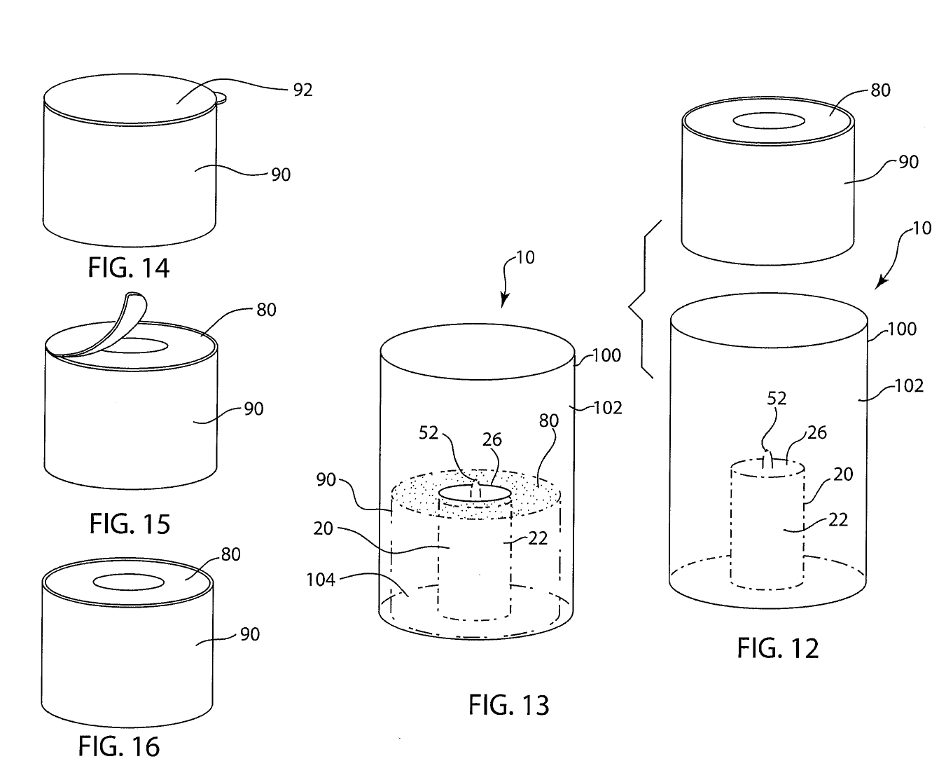

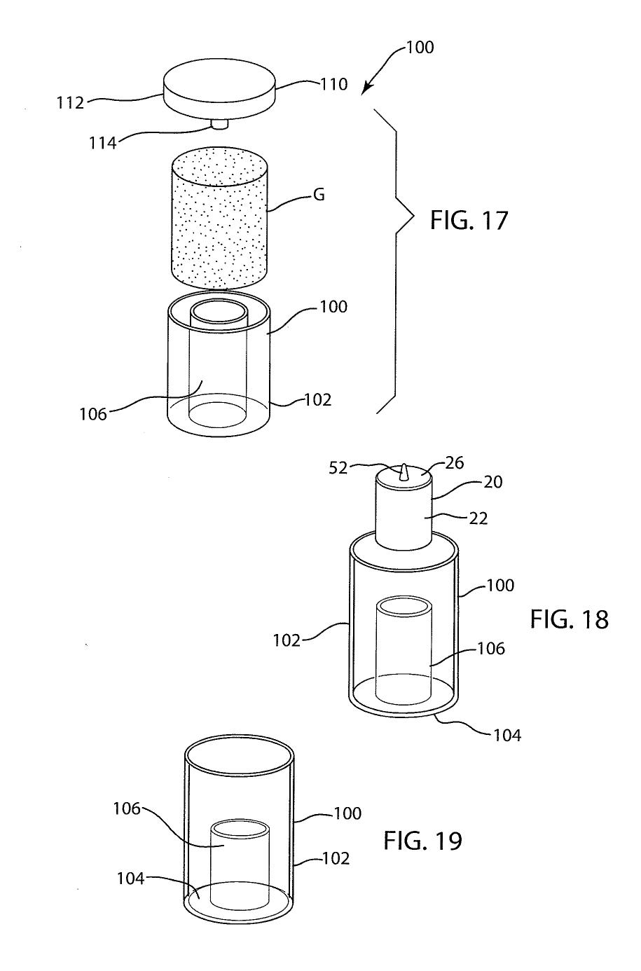

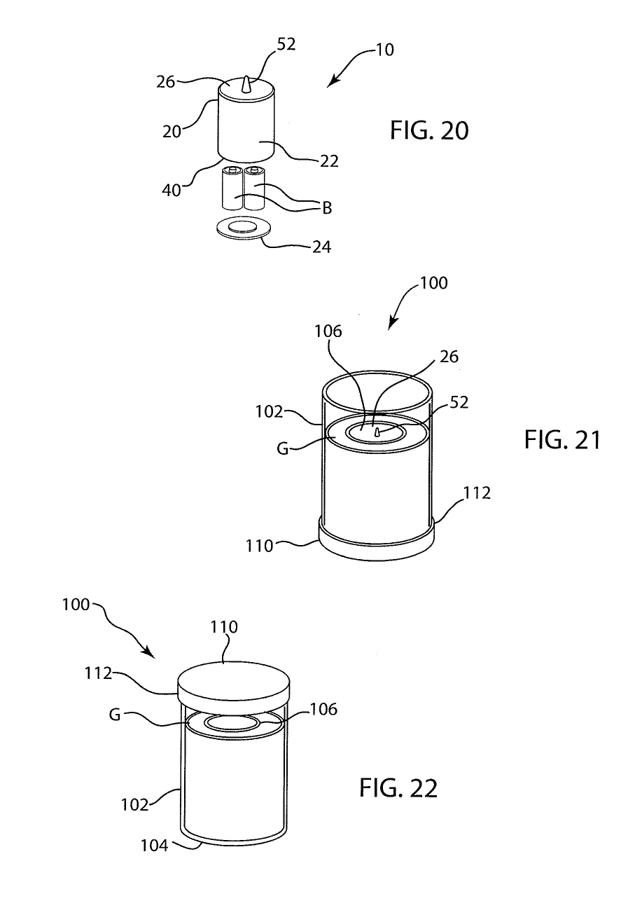

Referring to FIGS. 1-23, a simulated candle apparatus 10 is disclosed including an upright cylindrical housing 20 having a housing side wall 22, a housing bottom wall 24 and a detachable housing top wall 26 with a lighting circuit 50 affixed to the housing top wall lower surface and a light source connected to the lighting circuit 50 and extending above the housing top wall 26 to resemble a candle flame, the housing 20 containing a battery compartment 40 and a power circuit 60 including battery terminals (not shown) extending into the battery compartment 40, the power circuit 60 extending to and being in electrical communication with the lighting circuit 50, and one of the lighting circuit 50 and the power circuit 60 including a magnetic field activated light actuation switch in the form of a magnetically sensitive relay light activation switch 54. The apparatus 10 preferably is powered by an standard off-the-shelf battery B. The power circuit 60 can include plug prong terminals 62 extending from the lighting circuit and downwardly from the housing top wall 26 and a plug receptacle 64 having lead wires (not shown) extending to terminals (not shown) in the battery compartment 40. However, it is specifically preferred that the power circuit 60 include a battery holder 66 in which two contact arms 66A are soldered onto the PC board lighting circuit 50, rather than wires extending from the PC board. See FIG. 2A. The housing bottom wall 24 preferably is removable to provide access to the battery compartment. The light source 52 preferably is either a single color light emitting diode (LED) 52 which is caused to flicker. Alternatively the light source 52 is an LED 52 capable of emitting three different colors such as red, green and blue which are selectively illuminated according to the frequency of the electricity delivered to it. This alternative LED 52 may be part number LC14L314LWMC-20D manufactured by AMERICAN OPTO PLUS LED CORP.™. Housing 20 is placed inside a translucent cup 100 so that the apparatus becomes a tea light. Cup 100 has a candle cup side wall 102 and a candle cup bottom wall 104 and preferably has an upright tubular housing holder 106 secured to and extending upwardly from cup bottom wall 104. Cup 100 and housing holder preferably are transparent.

The apparatus 10 preferably includes a stick or wand 70 having a magnetic wand tip 72 for placement in activating proximity to the light actuation switch 54 to either activate or deactivate the light source 52 while resembling a candle lighting match.

The apparatus 10 is optionally a fragrance producing tea light, including a fragrance producing gel G. The fragrance producing gel G preferably is poured or otherwise deposited into the annular space between the cup side wall 102 and the tubular housing holder 106, and can be replaced with fresh gel G or with gel G of a different fragrance. The gel G fragrance can be preserved until the apparatus 10 is to be used by providing a gel covering sheet 92 which can be pealed off the gel G when needed. Alternatively, the gel G is contained within a solid annular gel pack cover 90 having a height substantially matching the height of the housing 20 and having an inner diameter sized to receive and closely fit around the tubular housing holder 106, so that the housing 20 and pack cover 90 appear in combination to be a candle, with the light source 52 protruding above housing 20 and gel pack cover 90. The gel pack cover 90 upper end has perforations or a separable pack lid 92 which is opened to release fragrance from the gel 80 to cause the pack cover 90 and housing 20 combination to resemble a scented candle. The gel pack cover 90 and retained housing 20 preferably are placed within a translucent and preferably transparent cylindrical container for resembling a cover or cup 100 as referenced above having a candle cup side wall 102 which fits closely around and extends above the gel pack cover 90 and housing 20, and has a contiguous candle cup bottom wall 104 and a removable cup cover defining a candle cup lid 110 with a downwardly extending peripheral lid flange 112 for fitting snugly around the exterior of the candle cup side wall 102 upper end. A contemplated alternative to the annular gel pack is an annular wax cylinder of the same dimensions, which preferably although not necessarily is scented.

The cup lid 110 preferably includes a magnetic rod 114 connected to and protruding downwardly from the lid 110 lower surface a sufficient distance to be proximal to and operate the magnetically sensitive relay switch, so that placing the cup lid 110 on the candle cup 100 operates the light activation switch 54 to deactivate the light source 52, just as the flame of a candle would be extinguished by placing a lid 110 on a candle cup, while removing the lid 110 from the candle cup 100 operates the light activated switch 54 to activate the light source 52. Alternatively rod 114 can be a magnetic disc 116, so that lid 110 is proximal to light activated switch 54 and activates light source 52 when placed under the candle cup 100.

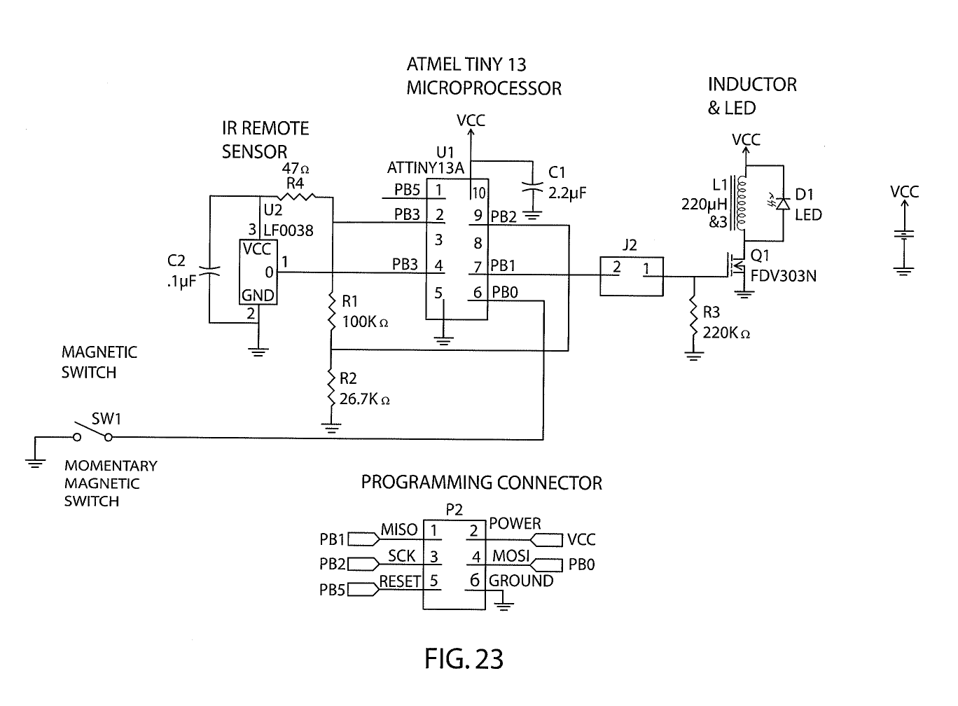

A remote control 120 preferably is also provided together with an infrared detector in the lighting circuit 50 or power circuit 60 for activating and deactivating the light source 54. The lighting circuit is shown in attached schematic marked as FIG. 23. An example of such a remote control is an ER hand paddle. The remote control 120 is particularly useful in restaurant settings, where one of the present apparatus is placed on each of numerous tables, so that they can be turned on or off in unison with a sweep of an arm and a single action of the remote control.

The lighting circuit 50 preferably provides the candle apparatus 10 logic within a single microprocessor chip utilizing the latest in state of the art nano-power computers in the AVR family from ATMEL™. Internal to the computer is both an analog-to-digital converter (ADC) to measure the battery B voltage and a pulse width modular (PWM) to control the voltage-to-current converter, that drives the light source 52. A single SMT inductor is used in the converter and the LED itself serves as a catch diode. This not only reduces part count (thereby increasing reliability), but it also provides for the highest possible conversion efficiency, since there are no extraneous components to consume precious battery B power.

Each time the LED simulated LED light source 52 is activated, the remaining battery B power level is sampled and the specific timing of the pulse width modulator is adjusted so that the average visual brightness of the light source 52 remains constant with time and does not diminish as the battery B ages. If it is determined that the battery B has exceeded its useful lifespan, the light source 52 is pulsed several times as an error indicator after which the apparatus 10 will return to the quiescent state. An inductor in the lighting circuit 50 also controls the current to prevent light source 52 from dimming and maintains a steady brightness intensity.

The flickering effect of the LED light source 52 is achieved by occasionally increasing and decreasing the brightness of the LED 52. The firmware controlling this flickering consists of two independent signal generators which each produce two sequences of pseudo-random timings. One signal generator is responsible for causing the LED 52 to occasionally brighten for a short period of time, while the other signal generator causes the LED 52 to dim down a similarly short period of time.

The brightening events recur quasi-periodically with an average repetition rate of 0.63 seconds. The dimming events recur at approximately 0.45 second intervals. The duration of both the event time and the normal time are randomized over a two to one range. The two random number generators follow a sixteen bit repeating binary coding sequence with a temporal resolution of 500 microseconds. The ON time and the subsequent OFF time are created from the results of sequential numbers from each of the two randomizers.

The lighting circuit 50 functions can be summarized as follows. The total effect of the randomization is that no discernable pattern to the flickering can be detected by a human observer. A Fourier analysis of the output signal would be confoundingly complex, with more than a hundred thousand nodes and with a strong emphasis on sub-hertz frequencies.

The apparatus 10 units may be ignited remotely by selecting one of the nine hour buttons on the IR hand paddle remote control 120, or locally by activating an internal magnetically sensitive relay light activation switch 54. The apparatus 10 will assume a default setting of five hours when it has been magnetically ignited. The apparatus 10 units may be extinguished remotely by selecting the OFF button on the IR hand paddle remote control 120 or locally by activating the internal magnetic light activation switch 54. If left unattended, each apparatus 10 unit will turn itself off after the pre-selected operational duration has transpired. A preferred contemplated battery B permits apparatus 10 to operate as long as 850 hours.

When in the OFF state, the apparatus 10 will remain in a shallow state of sleep and will still be ready and waiting for input from either the remote control 120 or the magnetic sensor. After one contiguous week of light sleep with no input from either the hand paddle remote control 120 or the magnetic light activation switch 54, the apparatus 10 will enter a much deeper state of sleep to further conserve battery B power and extend shelf life. Once in this condition of deep sleep, the apparatus 10 will require several seconds of continuous signal to wake and return to its operational state. This can be done by simply depressing and holding one of the hour buttons on the IR remote control 120 or by holding (not waving) the magnetic igniter wand 70 close to the apparatus 10.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A simulated candle apparatus, comprising:
an upright cylindrical housing having a tubular housing side wall and a housing bottom wall;
a detachable housing top wall having a housing top wall lower surface;
a lighting circuit affixed to said housing top wall;
a power circuit comprising a battery and being in electrical communication with said lighting circuit;
a light source connected to said lighting circuit and extending above said housing top wall to resemble a candle flame;
and one of said lighting circuit and said power circuit comprising a magnetic field activated light actuation switch.

2. The apparatus of claim 1, wherein said housing comprises a battery compartment containing said battery, and wherein said power circuit extends into said battery compartment.

3. The apparatus of claim 1, wherein said lighting circuit is mounted to said housing top wall lower surface.

4. The apparatus of claim 1, wherein said magnetic field activated light actuation switch comprises a magnetically sensitive relay light activation switch.

5. The apparatus of claim 1, wherein said power circuit comprises plug prong terminals extending from said lighting circuit and downwardly from said housing top wall and a plug receptacle electrically connected to said battery.

6. The apparatus of claim 1, wherein said lighting circuit is contained on a PC board.

7. The apparatus of claim 1, wherein said power circuit comprises a battery holder in which two contact arms are connected to said lighting circuit.

8. The apparatus of claim 2, wherein said housing bottom wall is removable to provide access to said battery compartment.

9. The apparatus of claim 1, wherein said light source is one of a single color light emitting diode which is caused to flicker and a light emitting diode capable of emitting multiple colors for selective illumination according to the frequency of electricity delivered to said light source.

10. The apparatus of claim 1, wherein said housing is placed inside a translucent cup such that said apparatus becomes a tea light.

11. The apparatus of claim 10, wherein said cup has a candle cup side wall and a candle cup bottom wall and has an upright tubular housing holder secured to and extending upwardly from said cup bottom wall.

12. The apparatus of claim 1, wherein said cup and housing holder are at least partially transparent.

13. The apparatus of claim 1, additionally comprises a wand having a magnetic wand tip for placement in activating proximity to said light actuation switch to one of activate and deactivate said light source while resembling a candle lighting match.

14. The apparatus of claim 1 wherein said apparatus is a fragrance producing tea light, comprising a fragrance producing, of gel.

15. The apparatus of claim 14, additionally comprising one of an annular fragrance producing gel and an annular wax cylinder positioned in an annular space between said cup side wall and the tubular housing, and can be replaced with another a fragrance producing gel.

16. The apparatus of claim 14, additionally comprising a gel covering sheet which can be pealed off the gel when needed;
such that the fragrance of said gel can be preserved until said apparatus is to be used.

17. The apparatus of claim 15, wherein said gel is contained within a solid annular gel pack cover having a height substantially matching the height of said housing and having an inner diameter sized to receive and closely fit around said tubular housing holder, such that said housing and said pack cover appear in combination to be a candle, with said light source protruding above said housing and gel pack cover.

18. The apparatus of claim 17, wherein said gel pack cover has one of an upper end with perforations and a separable pack lid which is opened to release fragrance from said gel to cause said pack cover and said housing combination to resemble a scented candle.

19. The apparatus of claim 17, wherein said gel pack cover and retained housing are placed within a translucent and transparent cylindrical container for resembling one of a cover and a cup as referenced above having a candle cup side wall which fits closely around and extends above said gel pack cover and said housing, and has a candle cup bottom wall and a removable cup cover defining a candle cup lid with a downwardly extending peripheral lid flange for fitting snugly around the exterior of said candle cup side wall.

20. The apparatus of claim 4, wherein said cup lid comprises a magnetic rod connected to and protruding downwardly from said lid lower surface a sufficient distance to be proximal to and operate the magnetically sensitive relay switch;
such that placing said cup lid on said candle cup operates said light activation switch to deactivate said light source, simulating how the flame of a candle would be extinguished by placing a lid on a candle cup, while removing said lid from said candle cup operates said light activated switch to activate said light source.

21. The apparatus of claim 4, wherein said cup lid comprises a magnetic disk connected to and protruding downwardly from said lid lower surface a sufficient distance to be proximal to and operate the magnetically sensitive relay switch;
such that placing said cup lid on said candle cup operates said light activation switch to deactivate said light source, simulating how the flame of a candle would be extinguished by placing a lid on a candle cup, while removing said lid from said candle cup operates said light activated switch to activate said light source.

22. The apparatus of claim 1, additionally comprising a remote control and an infrared detector in one of said lighting circuit and said power circuit for activating and deactivating said light source.

23. The apparatus of claim 1, wherein said lighting circuit comprises candle apparatus logic within a single microprocessor chip.

24. The apparatus of claim 1, wherein said lighting circuit operates such that when in the OFF state, said apparatus remains in a shallow state of sleep and remains ready and waiting for input from one of said remote control and said magnetic sensor, and after one contiguous week of light sleep with no input from either one of said remote control and said magnetic light activation switch, said apparatus enters a much deeper state of sleep to further conserve battery power and extend shelf life.
